(19) United States
(12) Patent Application Publication
(10) Pub. No.: US 2009/0256825 A1
(43) Pub. Date: Oct. 15, 2009

(54) PEN STYLUS ENABLED CAPACITIVE TOUCH SYSTEM AND METHOD

(76) Inventors: Gunnar Klinghult, Lund (SE); Paul Futter, Cary, NC (US)

Correspondence Address: HARRITY & HARRITY, LLP, 11350 RANDOM HILLS ROAD, SUITE 600, FAIRFAX, VA, 22030, US

(21) Appl. No.: 12/101,506

(22) Filed: Apr. 11, 2008

(51) Int. Cl. G06F 3/033

(52) U.S. Cl. 345/179

(57) ABSTRACT

Described is a capacitive touch screen apparatus. An indium tin oxide (ITO) ground screen covers and protects an optical display. One or more support structures are secured atop the ground screen layer. A first capacitance sensing patterned ITO trace layer is secured atop the support structures such that an air gap exists between the layers. A second capacitance sensing patterned ITO trace layer can be secured atop the first patterned ITO trace layer. A pointed object brought into contact with the outermost patterned ITO trace layer will deform the surface and penetrate a portion of the air gap sufficiently to register a change in capacitance at the point of contact. A protective transparent film layer covering the outermost patterned ITO trace layer can be utilized to protect the surface of the ITO layer from damage. The ITO layers are electronically coupled with a controller capable of sensing changes in capacitance.

### SUMMARY

Described is a capacitive touch screen apparatus. In one embodiment, an indium tin oxide (ITO) ground screen covers an optical display. One or more support structures are secured atop the ground screen layer. A first capacitance sensing patterned ITO trace layer is secured atop the support structures such that an air gap exists between the layers. A second capacitance sensing patterned ITO trace layer can be secured atop the first patterned ITO trace layer. A pointed object brought into contact with the outermost patterned ITO trace layer will deform the surface and penetrate a portion of the air gap sufficiently to register a change in capacitance at the point of contact. A protective transparent film layer covering the outermost patterned ITO trace layer can be utilized to protect the surface of the ITO layer from degradation and damage. The ITO layers are electronically coupled with a controller capable of sensing changes in capacitance.

In another embodiment, the support structures and air gap are replaced with a flexible transparent layer. When a pointed object such as a pen stylus contacts the outermost ITO layer (or protective film), the flexible layer is deformed sufficiently to register a change in capacitance on the ITO layer(s).

### BRIEF DESCRIPTION OF THE DRAWINGS

FIG. 1 is a prior art diagram that illustrates typical capacitive touch screen components.

FIG. 2 is a prior art diagram of an example of a dual layered ITO trace pattern that could be used with the invention.

FIG. 3 illustrates capacitive touch screen components according to one embodiment of the invention.

FIG. 4 illustrates capacitive touch screen components according to another embodiment of the invention.

FIG. 5 illustrates capacitive touch screen components according to another embodiment of the invention.

FIG. 6 illustrates capacitive touch screen components according to another embodiment of the invention.

FIG. 7 illustrates a description of a process that can be used to create a capacitive touch screen according to an embodiment of the invention.

FIG. 8 illustrates a description of a process that can be used to create a capacitive touch screen according to another embodiment of the invention.

FIG. 9 illustrates a description of a process that can be used to create a capacitive touch screen according to another embodiment of the invention.

FIG. 10 illustrates a description of a process that can be used to create a capacitive touch screen according to another embodiment of the invention.

FIGS. 11A-C illustrate one embodiment of the invention showing three levels of compression.

FIGS. 12A-C illustrate another embodiment of the invention showing three levels of compression.

### DETAILED DESCRIPTION OF THE INVENTION

Touch screens are becoming the user interface choice for many consumer electronics devices. One reason is their ability to reconfigure a display using software to define the graphical user interface. This alleviates the need for actual buttons, knobs, dials, scroll wheels, and other “hard” interface mechanisms. Since a device does not need to include the “hard” interface mechanisms, overall space is saved and a greater degree of flexibility is achieved.

There are several types of touch screens that have been developed. Each comes with distinct advantages and disadvantages. Resistive touch screens are in wide use. In general, a resistive touch screen includes opposing conductive layers of indium tin oxide (ITO) coated overlays separated by a small air gap. A plurality of insulating dots keep the conductive layers separated and partition the display area. When a finger or other implement contacts the outer conductive layer it flexes downward and contacts the other conductive layer creating unique electrical circuit properties that can be detected. The data is passed to a controller that can then determine what area of the screen has been touched and can use that information to trigger an event defined by a software interface. One of the advantages of resistive touch screens are their high resolution with respect to touch. Resistive touch screens can sense and interpret touches from implements that are smaller than and have a much smaller resolution than a finger.

Capacitive touch screens are another type of touch screen. In general, a capacitive touch screen works when at least one conductive layer including an indium tin oxide (ITO) coated overlay is charged. When a finger, which is also conductive, contacts the overlay it disrupts the charge on the screen. This disruption can be sensed and interpreted by an attached controller to determine the location of the touch. No air gap is required since the technology is not dependent on having one conductive layer contact another conductive layer. However, the resolution of a capacitive touch screen is not as good as a resistive touch screen since a finger is larger than other devices like pen styluses that can be used with resistive touch screens.

The embodiments described below provide for a capacitive touch screen that can be utilized with a pen type stylus (or other pointing device) to increase the resolution that can be achieved with the capacitive touch screen without introducing resistive technology into the system.

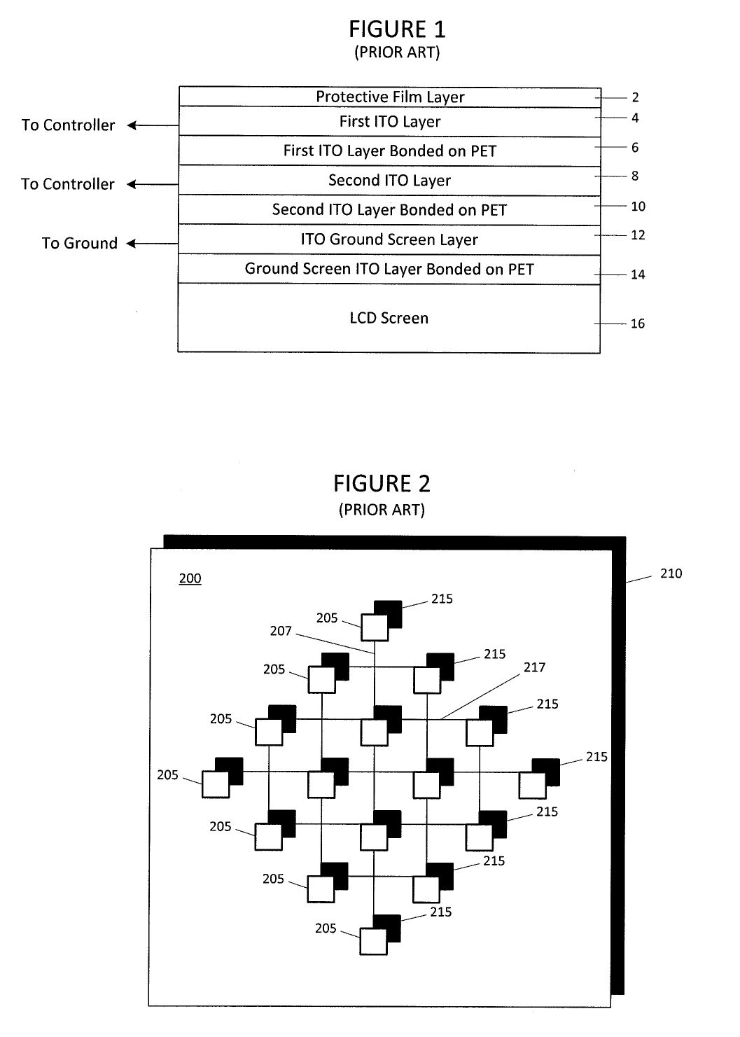

FIG. 1 is a prior art cross-sectional diagram that illustrates typical capacitive touch screen components in greater detail than that described above. A typical capacitive touch screen includes a protective film layer 2 that covers a first indium tin oxide (ITO) layer 4. The protective film layer 2 can comprise most any flexible transparent plastic material and serves to protect the ITO layer 4 from degradation due to the oils associated with a human finger touch as well as damage from more pointed objects. The first ITO layer 4 is typically a pattern of ITO traces embedded onto a clear substrate such as, but not limited to, polyethylene terephthalate (PET) 6. The pattern of the traces aid in determining location of a capacitive changing touch to the screen. A second ITO layer 8 embedded on a second PET substrate 10 having another pattern can also be utilized. In most instances, the first ITO layer 4 will have ITO traces running in one direction (x-axis) while the second ITO layer 8 will have ITO traces running in another direction (y-axis). This matrix type design further assists in identifying location and direction of a touch. An ITO ground screen layer 12 bonded on another PET substrate 14 protects the capacitive ITO layers from the emissions of an LCD screen 16 that actually displays the graphical user interface.

The number of ITO traces and the pattern they present is a design choice that can be tailored to best suit the application(s) contemplated by the device. FIG. 2 is a prior art diagram of an example of a dual layered ITO trace pattern that could be used with the invention. In this example, there are two substrates 200, 210 that could be, for instance, polyethylene terephthalate (PET). On each substrate 200, 210 there are bonded a pattern of ITO traces and connectors. On the top substrate 200, the traces 205 are inter-connected with conductive elements 207 in a y-axis or vertical orientation. Similarly, on the bottom substrate 210, the traces 215 are inter-connected with conductive elements 217 in a x-axis or horizontal orientation. By using the two layers, one for horizontal touch/motion sensing and one for vertical touch/motion sensing, the capacitive touch screen as a whole is able to accurately pinpoint the current position of a touch on the screen.

When a finger contacts the protective film layer 2 somewhere on the surface of the display, the first 4 and second 8 ITO layers register a change in the capacitance between the nearest ITO traces at the point of the touch. This information is relayed from the conductive traces to a controller that can process the change and determine the location of the touch. If the touch is “moving” across the display, the traces will pick up capacitance changes wherever the finger happens to be. These changes can all be processed to interpret the motion of a finger across the display.

If the touch or motion is in a software defined area that indicates a specific type of user input, the software will act appropriately to carry out any instructions associated with the touch. For instance, the display can present an image of a volume slider bar. If the user touches the slider bar and moves it up or down to indicate a desired change in volume output, the controller will be able to determine that the user is indeed attempting to change the volume because he is touching the screen in an area defined as volume control. If the touch is moving up the image of the volume bar, that will be interpreted as a signal to raise the volume.

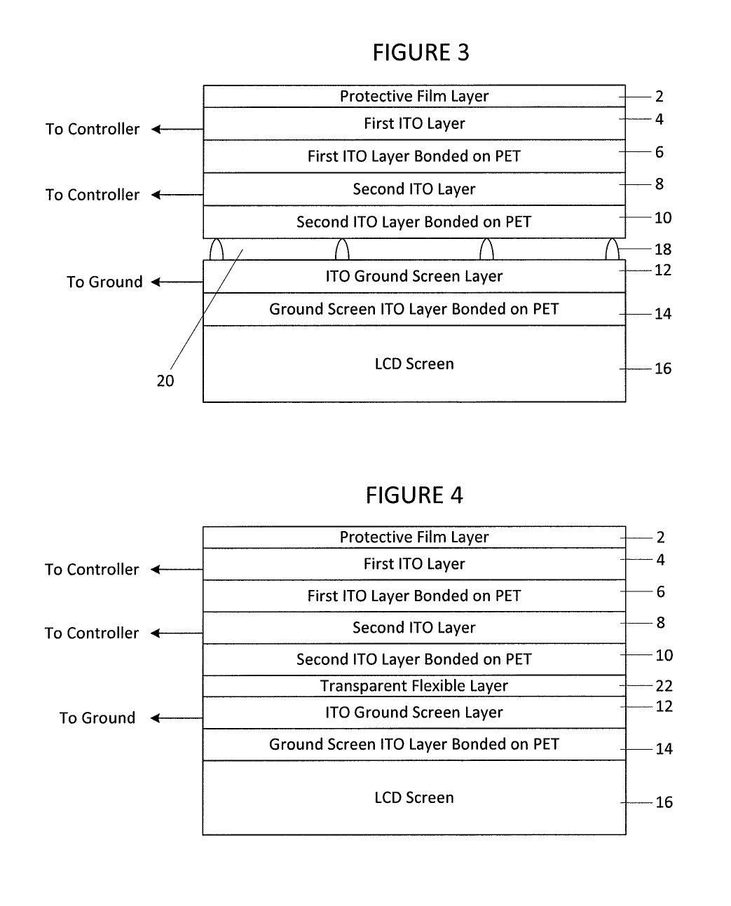

FIG. 3 is a cross-sectional illustration of capacitive touch screen components according to one embodiment of the invention. As mentioned above, the capacitive touch screen works when it is able to sense a change in the expected capacitance at a particular location on the display. Since a user's finger is a conductive element itself, its proximity to the screen will affect the capacitance on the ITO layers 4, 6. No deflection of a layer or physical contact with another layer is required to alter the capacitance. However, use of a pen stylus, for instance, on a typical capacitive touch screen will not register enough of a change in the capacitance to be considered a detectable event. Thus, the resolution of the typical capacitive touch screen appears limited to that of a finger.

FIG. 3 is similar to FIG. 1 with the exception that a small air gap 20 has been introduced between the second ITO layer 10 bonded on a PET substrate 12 and the ground screen ITO layer 12 bonded on a PET substrate 14. A plurality of insulating dots 18 (or other support mechanism) are used to support the upper layers from contacting the ground screen ITO layer 12 thereby creating the air gap 20. The air gap 20 will have no effect when a finger is used to interact with the display. That is, the capacitive touch screen will work as it always does when a finger is the input device. However, when a pen stylus is used, the air gap 20 will allow for a small deflection of the upper ITO layers 4, 8 when touched. This small deflection is absorbed by the air gap and will create a detectable capacitance change in the ITO layers 4, 8 at the location of the deflection. Thus, a capacitive touch screen can be used with a pen type stylus or the like. This greatly increases the resolution of the input device for applications that call for higher resolution input.

FIG. 4 is a cross-sectional illustration of capacitive touch screen components according to another embodiment of the invention. This figure is similar to FIG. 3 except that the air gap has been replaced with a transparent flexible layer 22. The flexible layer is transparent so as to allow the LCD to emit as much light as possible through. This transparent flexible layer 22 will be deformed when a pen type stylus contacts the outer protective film 2. The small deformation is a detectable event with respect to capacitive change in the upper ITO layers 4, 8. Again, this greatly increases the resolution of the input device for applications (such as, for instance, hand writing entry and recognition) that call for higher resolution input.

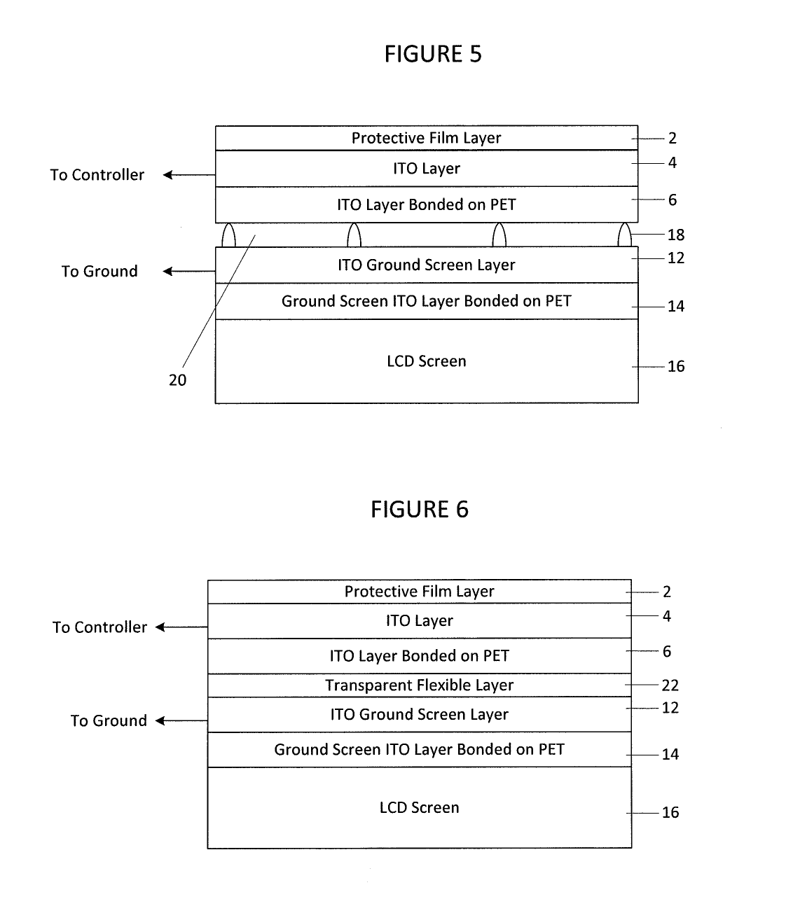

FIG. 5 is a cross-sectional illustration of capacitive touch screen components according to another embodiment of the invention. As briefly mentioned earlier, the upper ITO layer(s) that include the pattern of conductive ITO traces can be configured to detect and pinpoint a touch. The previous embodiments have described the use of two conductive ITO layers each having a different pattern to assist in location determination of a touch. It is also possible to utilize only one conductive ITO layer 4 having a pattern capable of determining a touch location. Thus, FIG. 5 is similar to FIG. 3 except that the second ITO layer 8 and its associated substrate 10 have been removed. The remainder of the description associated with FIG. 3 applies equally to FIG. 5.

FIG. 6 is a cross-sectional illustration of capacitive touch screen components according to another embodiment of the invention. Referring to the discussion relating to FIG. 5 above, FIG. 6 is similar to FIG. 4 except that the second ITO layer 8 and its associated substrate 10 have been removed. The remainder of the description associated with FIG. 4 applies equally to FIG. 6.

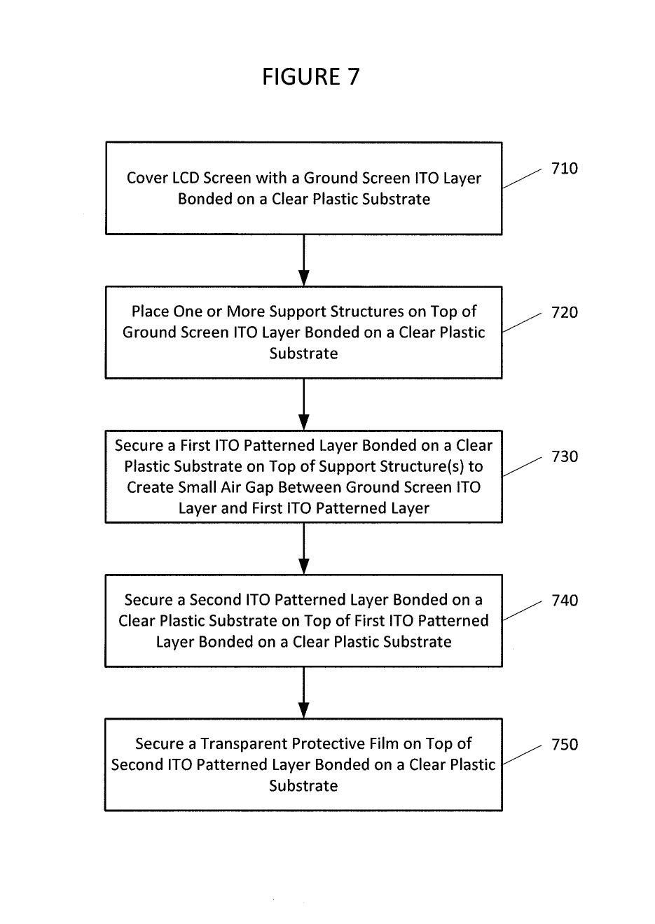

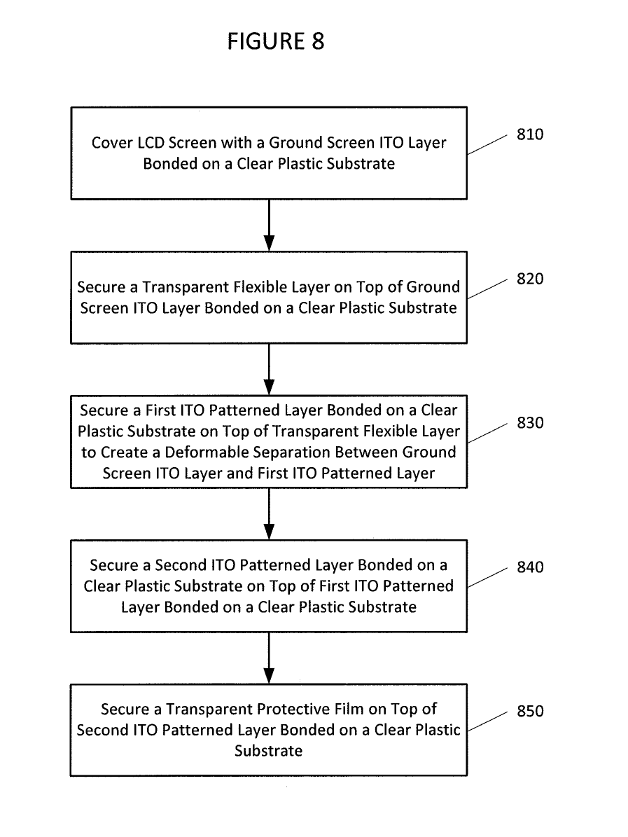

FIG. 7 illustrates a description of a process that can be used to create a capacitive touch screen according to an embodiment of the invention. The steps described in FIG. 7 will yield a capacitive touch screen like that shown in FIG. 3. Creating a capacitive touch screen implies that an actual screen capable of displaying, to a relatively high degree of resolution, textual and graphical data is to be used beneath the touch screen elements. The first step is to cover such a screen (e.g., an LCD screen) with a ground screen ITO layer that is bonded to a clear plastic substrate 710. This ground screen ITO layer substantially blocks the LCD emissions to protect the capacitive sensing ITO layers above from damaging LCD emissions. One or more insulating dots or other type of support mechanism are dispersed on top of the ground screen layer 720. A first ITO patterned trace layer bonded to a clear plastic substrate is positioned and secured atop the support mechanism 730. This creates a small uniform air gap that separates the ground screen ITO layer from the upper ITO trace layers. A second ITO patterned trace layer bonded to a clear plastic substrate is positioned and secured atop the first ITO patterned trace layer 740. Finally, a transparent protective film layer is affixed atop the second ITO patterned layer 750. The protective film primarily serves to protect the ITO patterned layers from degradation due to oils of a human finger or damage by sharp implements that may disrupt or even disable the capacitive sensing abilities of the device.

FIG. 8 illustrates a description of a process that can be used to create a capacitive touch screen according to another embodiment of the invention. The steps described in FIG. 8 will yield a capacitive touch screen like that shown in FIG. 4. Again, the first step is to cover such a screen (e.g., an LCD screen) with a ground screen ITO layer that is bonded to a clear plastic substrate 810. This ground screen ITO layer substantially blocks the LCD emissions to protect the capacitive sensing ITO layers above from damaging LCD emissions. A transparent flexible layer is positioned and secured atop the ground screen ITO layer 820. A first ITO patterned trace layer bonded to a clear plastic substrate is positioned and secured atop the transparent flexible layer 830. The flexible nature of this transparent layer will deform upon impact from an implement such as a pen stylus. The deformation is enough to register a capacitance change. A second ITO patterned trace layer bonded to a clear plastic substrate is positioned and secured atop the first ITO patterned trace layer 840. Finally, a transparent protective film layer is affixed atop the second ITO patterned layer 850. The protective film primarily serves to protect the ITO patterned layers from degradation due to oils of a human finger or damage by sharp implements that may disrupt or even disable the capacitive sensing abilities of the device.

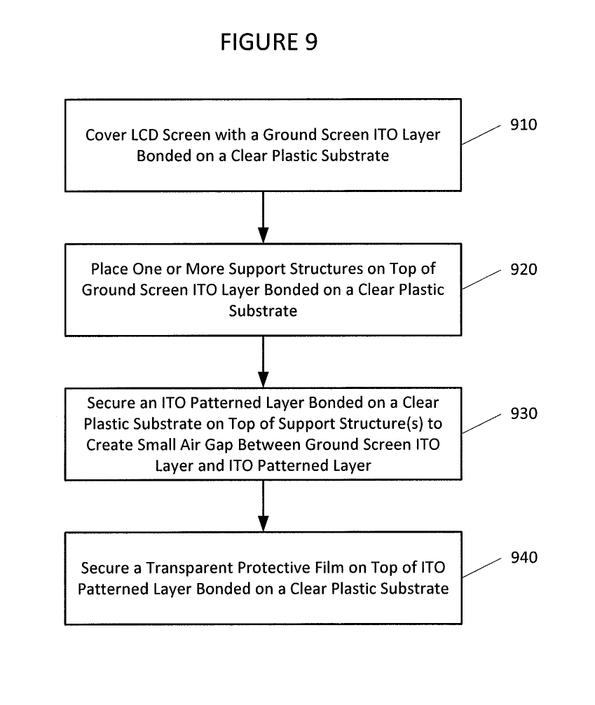

FIG. 9 illustrates a description of a process that can be used to create a capacitive touch screen according to another embodiment of the invention. The steps described in FIG. 9 will yield a capacitive touch screen like that shown in FIG. 5. Again, the first step is to cover such a screen (e.g., an LCD screen) with a ground screen ITO layer that is bonded to a clear plastic substrate 910. This ground screen ITO layer substantially blocks the LCD emissions to protect the capacitive sensing ITO layers above from damaging LCD emissions. One or more insulating dots or other type of support mechanism are dispersed on top of the ground screen layer 920. An ITO patterned trace layer bonded to a clear plastic substrate is positioned and secured atop the support mechanism 930. This creates a small uniform air gap that separates the ground screen ITO layer from the upper ITO trace layer. Finally, a transparent protective film layer is affixed atop the second ITO patterned layer 940. The protective film primarily serves to protect the ITO patterned layers from degradation due to oils of a human finger or damage by sharp implements that may disrupt or even disable the capacitive sensing abilities of the device.

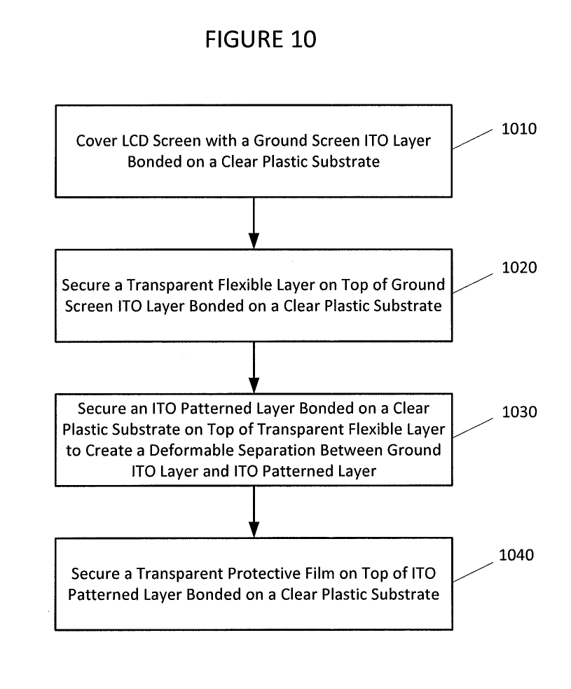

FIG. 10 illustrates a description of a process that can be used to create a capacitive touch screen according to another embodiment of the invention. The steps described in FIG. 10 will yield a capacitive touch screen like that shown in FIG. 6. Again, the first step is to cover such a screen (e.g., an LCD screen) with a ground screen ITO layer that is bonded to a clear plastic substrate 1010. This ground screen ITO layer substantially blocks the LCD emissions to protect the capacitive sensing ITO layers above from damaging LCD emissions. A transparent flexible layer is positioned and secured atop the ground screen ITO layer 1020. An ITO patterned trace layer bonded to a clear plastic substrate is positioned and secured atop the transparent flexible layer 1030. The flexible nature of this transparent layer will deform upon impact from an implement such as a pen stylus. The deformation is enough to register a capacitance change. Finally, a transparent protective film layer is affixed atop the second ITO patterned layer 1040. The protective film primarily serves to protect the ITO patterned layers from degradation due to oils of a human finger or damage by sharp implements that may disrupt or even disable the capacitive sensing abilities of the device.

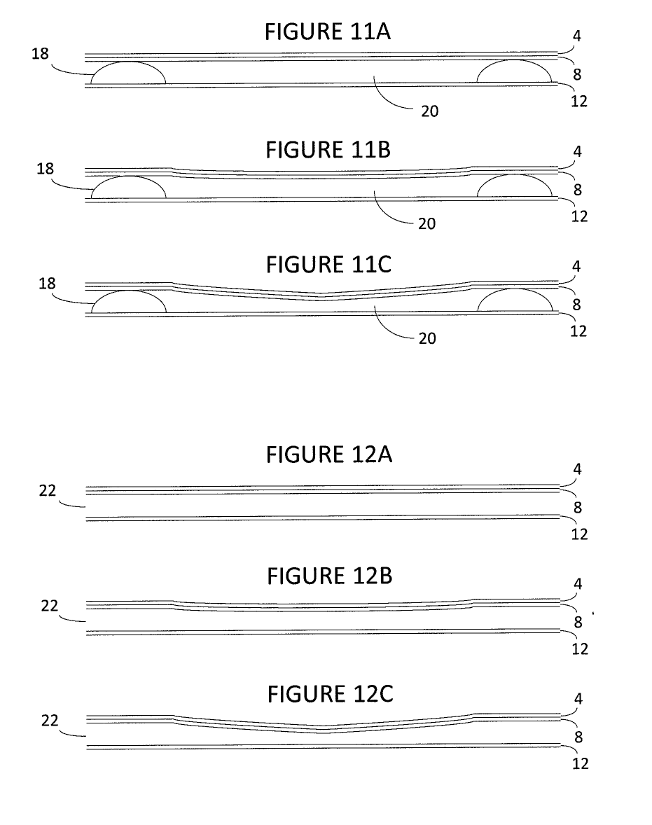

FIGS. 11A-C illustrate one embodiment of the invention showing three levels of compression. FIG. 11A shows the components of a capacitive touch screen prior to contact from a finger or pen type stylus. There is no compression in either of the ITO layers 4, 8 as they rest above ground screen layer 12 and on top of insulating dots 18. The air gap 20 remains unaffected. FIG. 11B shows the components of a capacitive touch screen after an initial contact from a finger or pen type stylus. There is a slight compression in both of the ITO layers 4, 8 as they rest above ground screen layer 12 and on top of insulating dots 18. The air gap 20 is slightly affected. The slight depression of the ITO layers 4, 8 causes a relatively linear change in capacitance. FIG. 11C shows the components of a capacitive touch screen after a sustained contact from a finger or pen type stylus. There is a greater compression in both of the ITO layers 4, 8 than in FIG. 11B as they rest above ground screen layer 12 and on top of insulating dots 18. The air gap 20 is more affected. The greater depression of the ITO layers 4, 8 is reflected in a linear change in capacitance with respect to that shown in FIG. 11B.

The initial contact causes a first change in capacitance and the stronger sustained contact causes a second change in capacitance. These changes in capacitance are relatively linear and can be quantified and utilized by other software applications as input. For instance, the user may contact a portion of the LCD screen reserved for zoom control of the display. An initial contact can trigger the zoom function while a stronger contact can quantify how much or how fast to zoom the image on the display. Similarly, the user may contact a portion of the LCD screen reserved for volume control of an application such as MP3 playback. An initial contact can trigger the volume function while a stronger contact can quantify how much or how fast to raise or lower the volume.

FIGS. 12A-C illustrate another embodiment of the invention showing three levels of compression.

As will be appreciated by one of skill in the art, the present invention may be embodied as a system or method.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A capacitive touch screen apparatus comprising:
an indium tin oxide (ITO) ground screen layer bonded to a clear plastic substrate;
one or more support structures secured atop the ground screen layer; and
a first patterned ITO trace layer bonded to a clear plastic substrate and electronically coupled with a controller capable of sensing a change in capacitance, the first patterned ITO trace layer bonded to a clear plastic substrate secured atop the one or more support structures such that an air gap exists between the first patterned ITO trace layer bonded to a clear plastic substrate and the ground screen layer bonded to a clear plastic substrate wherein the first patterned ITO trace layer bonded to a clear plastic substrate substantially covers the ground screen layer bonded to a clear plastic substrate,
such that a pointed object brought into contact with the first patterned ITO trace layer bonded to a clear plastic substrate will deform the surface and penetrate a portion of the air gap sufficiently to register a change in capacitance at the point of contact.

2. The capacitive touch screen apparatus of claim 1 further comprising:
a second patterned ITO trace layer bonded to a clear plastic substrate electronically coupled with a controller capable of sensing a change in capacitance, the second patterned ITO trace layer bonded to a clear plastic substrate secured atop and substantially covering the first patterned ITO trace layer bonded to a clear plastic substrate.

3. The capacitive touch screen apparatus of claim 1 further comprising a protective transparent film layer substantially covering the first patterned ITO trace layer bonded to a clear plastic substrate.

4. The capacitive touch screen apparatus of claim 2 further comprising a protective transparent film layer substantially covering the second patterned ITO trace layer bonded to a clear plastic substrate.

5. The capacitive touch screen apparatus wherein the one or more support structures are insulating dots.

6. A capacitive touch screen apparatus comprising:
an indium tin oxide (ITO) ground screen layer bonded to a clear plastic substrate;
a transparent flexible layer secured to and substantially covering the ground screen layer; and
a first patterned ITO trace layer bonded to a clear plastic substrate and electronically coupled with a controller capable of sensing a change in capacitance, the first patterned ITO trace layer bonded to a clear plastic substrate secured atop the transparent flexible layer,
such that a pointed object brought into contact with the first patterned ITO trace layer bonded to a clear plastic substrate will deform the surface and penetrate a portion of the transparent flexible layer sufficiently to register a change in capacitance at the point of contact.

7. The capacitive touch screen apparatus of claim 6 further comprising:
a second patterned ITO trace layer bonded to a clear plastic substrate electronically coupled with a controller capable of sensing a change in capacitance, the second patterned ITO trace layer bonded to a clear plastic substrate secured atop and substantially covering the first patterned ITO trace layer bonded to a clear plastic substrate.

8. The capacitive touch screen apparatus of claim 6 further comprising a protective transparent film layer substantially covering the first patterned ITO trace layer bonded to a clear plastic substrate.

9. The capacitive touch screen apparatus of claim 7 further comprising a protective transparent film layer substantially covering the second patterned ITO trace layer bonded to a clear plastic substrate.

10. A method of constructing a capacitive touch screen apparatus comprising:
securing one or more support structures atop an indium tin oxide (ITO) ground screen layer bonded to a clear plastic substrate; and
securing a first patterned ITO trace layer bonded to a clear plastic substrate atop the one or more support structures such that an air gap exists between the first patterned ITO trace layer bonded to a clear plastic substrate and the ground screen layer bonded to a clear plastic substrate wherein the first patterned ITO trace layer bonded to a clear plastic substrate substantially covers the ground screen layer bonded to a clear plastic substrate.

11. The method of claim 10 further comprising:
securing a second patterned ITO trace layer bonded to a clear plastic substrate atop and substantially covering the firs t patterned ITO trace layer bonded to a clear plastic substrate.

12. The method of claim 10 further comprising substantially covering the first patterned ITO trace layer bonded to a clear plastic substrate with a protective transparent film layer.

13. The method of claim 11 further comprising substantially covering the second patterned ITO trace layer bonded to a clear plastic substrate with a protective transparent film layer.

14. The method of claim 10 wherein the one or more support structures are insulating dots.

15. A method of constructing a capacitive touch screen apparatus comprising:
securing a transparent flexible layer substantially atop an indium tin oxide (ITO) ground screen layer bonded to a clear plastic substrate; and
securing a first patterned ITO trace layer bonded to a clear plastic substrate atop the transparent flexible layer wherein the first patterned ITO trace layer bonded to a clear plastic substrate substantially covers the ground screen layer bonded to a clear plastic substrate.

16. The method of claim 15 further comprising:
securing a second patterned ITO trace layer bonded to a clear plastic substrate atop and substantially covering the firs t patterned ITO trace layer bonded to a clear plastic substrate.

17. The method of claim 15 further comprising substantially covering the first patterned ITO trace layer bonded to a clear plastic substrate with a protective transparent film layer.

18. The method of claim 16 further comprising substantially covering the second patterned ITO trace layer bonded to a clear plastic substrate with a protective transparent film layer.

19. A method of interpreting capacitive touch screen contacts wherein the capacitive touch screen includes a deformable space between at least one capacitive sensing ITO layer and an ITO ground screen layer, the method comprising:
sensing a first capacitance change resulting from an initial contact to the at least one ITO layer that results in a slight deformation in the space between the at least one ITO layer and the ITO ground screen layer wherein the first sensed capacitance change triggers a function;
sensing a second capacitance change resulting from a stronger sustained contact to the at least one ITO layer that results in a greater deformation in the space between the at least one ITO layer and the ITO ground screen layer wherein the second sensed capacitance change affects how the function is carried out.

20. The method of claim 19 wherein the deformable space is an air gap.

21. The method of claim 19 wherein the deformable space is comprised of a deformable flexible transparent plastic material.
